(19) United States
(12) Patent Application Publication
(10) Pub. No.: US 2011/0068859 A1
(43) Pub. Date: Mar. 24, 2011

(54) SEMICONDUCTOR DEVICE

(75) Inventor: Masakatsu NAKAI, Kanagawa (JP)

(73) Assignee: Sony Corporation, Tokyo (JP)

(21) Appl. No.: 12/883,804

(22) Filed: Sep. 16, 2010

(30) Foreign Application Priority Data
Sep. 18, 2009 (JP) 2009-217472

(51) Int. Cl. G05F 1/10

(52) U.S. Cl. 327/540

(57) ABSTRACT

A semiconductor device includes: a power supply voltage generating circuit generating a power supply voltage corresponding to delay information; and an integrated circuit to which the power supply voltage is supplied from the power supply voltage generating circuit, wherein the integrated circuit includes at least one delay information monitor monitoring delay information at the time of operation when the power supply voltage is supplied from the power supply voltage generating circuit and a delay information manager managing delay information acquired by the delay information monitor, the power supply voltage generating circuit includes a delay information register which can hold delay information relating to delay information by the delay information monitor and a voltage control circuit generating the power supply voltage corresponding to delay information stored in the delay information register and supplies the voltage to the integrated circuit.

### BACKGROUND OF THE INVENTION

1. Field of the Invention

The present invention relates to a semiconductor device including a power supply voltage generating circuit for supplying the minimum power supply voltage in which a system LSI (referred to as an LSI in the following description) can be operated to thereby reduce power consumption of the LSI.

2. Description of the Related Art

For example, in the LSI including a CMOS, it is most effective that the power supply voltage is reduced in order to cut down power consumption.

Means for determining/supplying the optimum power supply voltage have been variously proposed until now (for example, refer to JP-A-2000-295084 (Japanese Patent No. 41114291) (Patent Document 1) and JP-A-2003-60052 (Japanese Patent No. 3478284) (Patent Document 2)).

In the proposed technique, a power supply voltage satisfying time constraint in operation of the LSI is determined by measuring delay information of a monitor circuit inside the LSI at any time and a voltage value is indicated to a power supply generating circuit (referred to as a power supply IC).

In the proposed technique, delay information of a delay monitor circuit in a semiconductor is measured at the time of a shipping test, and delay information or information of the power supply voltage is stored in a register inside the LSI. The information is read at the time of operating the LSI and the voltage value is indicated to the power supply IC.

### SUMMARY OF THE INVENTION

As described above, the method in which delay information of the delay monitor circuit in the LSI is measured, the result in a nonvolatile memory element in the LSI is recorded, the value is read at the time of activating the LSI and the voltage value is indicated to the power supply IC has been taken in related art.

As another method, delay information of the delay monitor circuit in the LSI is read at any time and voltage values are indicated to the power supply IC at each time.

Accordingly, in the proposed techniques, a communication means between the LSI and the power supply IC at the time of operating the LSI and firmware for controlling the power supply IC are necessary.

Additionally, a period for initialization of controlling voltage values by controlling the power supply IC at the time of activating the LSI is necessary.

Moreover, a dedicated pin for performing communication between the power supply IC and the LSI is necessary, which may lead to increase of the chip size.

As firmware intervention is also necessary at the time of activating the LSI, man-hour for development and verification of firmware increasing with the circuit scale has effects.

Furthermore, in existing advanced processes, mounting of the nonvolatile memory element inside the LSI leads to cost increase of the LSI.

Thus, it is desirable to provide a semiconductor device capable of realizing supply of the optimum power supply voltage while suppressing costs for development and verification because the nonvolatile memory element is not necessary inside the LSI, firmware for controlling the power supply IC and communication between the power supply IC and the LSI are not necessary and pins on the side of the LSI can be cut.

According to an embodiment of the invention, there is provided semiconductor device including a power supply voltage generating circuit generating a power supply voltage corresponding to delay information and an integrated circuit to which the power supply voltage is supplied from the power supply voltage generating circuit, in which the integrated circuit has a delay information monitor monitoring delay information at the time of operation when the power supply voltage is supplied from the power supply voltage generating circuit and a delay information manager managing delay information acquired by the delay information monitor, and the power supply voltage generating circuit has a delay information register which can hold delay information relating to delay information by the delay information manager and a voltage control circuit generating the power supply voltage corresponding to delay information stored in the delay information register and supplies the voltage to the integrated circuit.

According to the above and another embodiment of invention, the optimum power supply voltage can be supplied while suppressing costs for development and verification because the nonvolatile memory element is not necessary inside the LSI, firmware for controlling the power supply IC and communication between the power supply IC and the LSI are not necessary and pins on the side of the LSI can be cut.

### BRIEF DESCRIPTION OF THE DRAWINGS

FIG. 1 is a diagram showing a configuration example of a semiconductor device according to a first embodiment of the invention;

FIG. 2 is a diagram showing a first configuration example of a delay information monitor according to the embodiment;

FIG. 3 is a diagram showing a second configuration example of the delay information monitor according to the embodiment;

FIG. 4 is a flowchart for explaining an example of a power supply voltage control process by delay information according to the first embodiment;

FIG. 5 is a diagram showing a configuration example of a semiconductor device according to a second embodiment of the invention;

FIG. 6 is a diagram showing a configuration example of a semiconductor device according to a third embodiment of the invention; and

FIG. 7 is a diagram showing a configuration example of a semiconductor device according to a fourth embodiment of the invention.

### DESCRIPTION OF THE PREFERRED EMBODIMENTS

Hereinafter, embodiments of the invention will be explained with reference to the drawings.

The explanation will be made in the following order.

1. First Embodiment (First configuration example of a semiconductor device)

2. Second Embodiment (Second configuration example of the semiconductor device)

3. Third Embodiment (Third configuration example of the semiconductor device)

4. Fourth Embodiment (Fourth configuration example of the semiconductor device)

### 1. First Embodiment

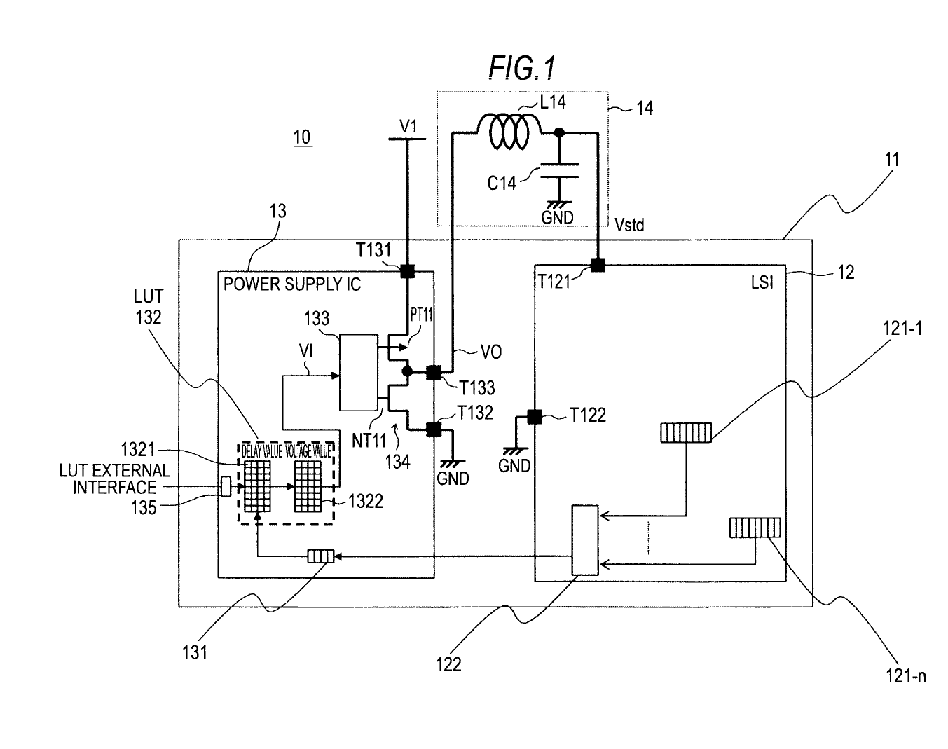

FIG. 1 is a diagram showing a configuration example of a semiconductor device according to a first embodiment of the invention.

A present semiconductor device 10 includes a package substrate 11, an LSI (integrated circuit) 12, a power supply IC (power supply voltage generating circuit) 13 and a smoothing circuit 14.

The present embodiment is an embodiment for supplying an individually optimized voltage to each LSI in a power supply IC 13 and an LSI 12 to be paired for use.

In recent years, there are many cases in which plural LSI chips are mounted in one package. As plural LSIs are sealed in the same package, the combination thereof is determined uniquely.

The present embodiment realizes supply of the individually-optimized power supply voltage easily by exploiting the feature.

In a broad sense, the combination of plural LSIs mounted on an actual device substrate can be regarded as unique, therefore, the embodiment is not limited to the inside of the same package and can be also applied to the whole actual device substrate.

Hereinafter, configurations and functions of respective units of the semiconductor device 10 according to the first embodiment will be specifically explained.

In the first embodiment, a case in which the power supply IC 13 and the LSI 12 are mounted in the same package substrate 11 is shown.

The LSI 112 includes a power supply terminal T121 and a ground terminal T122.

To the power supply terminal T121, a power supply voltage Vstd by the power supply IC 13 smoothed by a smoothing circuit 14 is supplied.

The ground terminal T122 is connected to a ground GND of the package substrate 11.

Not-shown functional blocks are mounted on the LSI 112.

On the LSI 112, plural delay information monitors 121-1 to 121-n and a delay information manager 122 are mounted.

In this case, plural delay information monitors are mounted, however, one or plural delay information monitors may be mounted and the number of monitors is not limited.

The delay information monitors 121 (−1 to −n) acquire delay information in a case in which the power supply voltage Vtd by the power supply IC 13 smoothed by the smoothing circuit 14 is supplied to the power supply terminal T121, for example, at the time of activating the LSI or at the time of the shipping test and outputs the information to the delay information manager 122.

For example, when delay information is measured at a fixed reference voltage, the LSI having slow operation speed of a transistor has a large delay value, and the LSI having high operation speed of the transistor has a small delay value in manufacturing variation (process variation) of LSIs.

The delay information monitors 121 (−1 to −n) generate delay monitor signals indicating a manufactured state of the semiconductor device 10 (finished state) in accordance with an enable signal EN supplied from, for example, a not-shown control system in the LSI 112 and transfers the signals to the delay information manager 122.

The delay information monitors 121 acquire data, for example, indicating a process variation state of the semiconductor device 10.

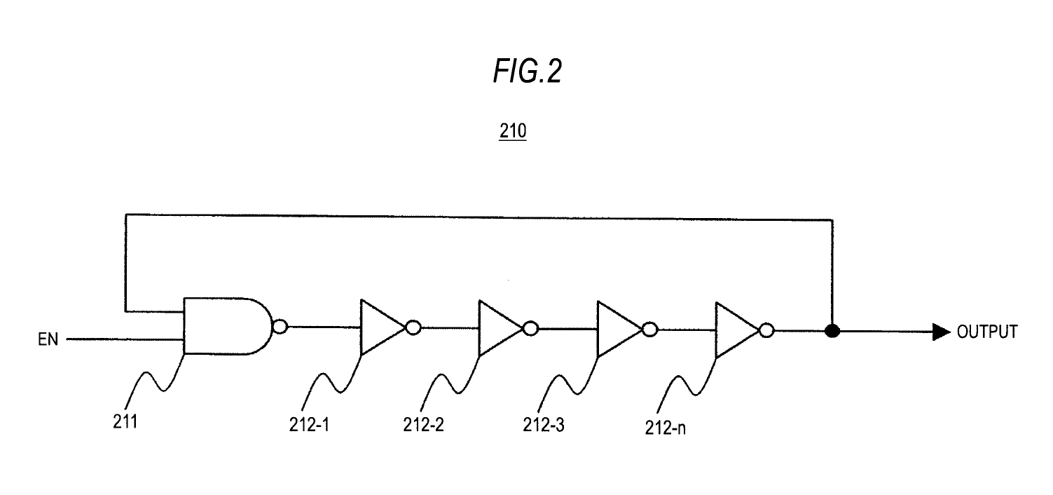

FIG. 2 is a diagram showing a first configuration example of the delay information monitor according to the embodiment.

A delay information monitor 210 of FIG. 2 includes a 2-input NAND gate 211 and even numbers of inverters 212-1, 212-2, . . . 212-n which are cascade-connected to an output section on of the 2-input NAND gate.

The monitor is configured to have a ring oscillator in which part of output from the inverter 212-n is fed back to one input terminal of the NAND gate 211.

The enable signal EN from the not-shown control system is inputted to the other input terminal of the NAND gate 211.

It is also possible that output of the ring oscillator is directly outputted to the delay information manager 122, the delay information manager 122 is allowed to measure a frequency and the result is applied as delay information.

For example, the delay information manager 122 can determine that the operation speed is high and the delay value is small when the frequency is high, and can determine that the operation speed is low and the delay value is large when the frequency is low.

It is also possible that output of the ring oscillator is directly outputted to an external terminal of the semiconductor device 10 and a test device is allowed to measure the frequency.

When the oscillation frequency of the ring oscillator is extremely high, an outputted oscillation clock may be divided, then, outputted to the outside of the semiconductor device 10.

It is also possible to mount a frequency counter and a frequency value measured by the counter is outputted.

The signal outputted from the ring oscillator included in the delay information monitor 210 and read in the delay information manager 122 is enough as long as the signal indicates the delay variation state of the semiconductor device 10, and it is convenient that the signal is readable for the delay information manager 122.

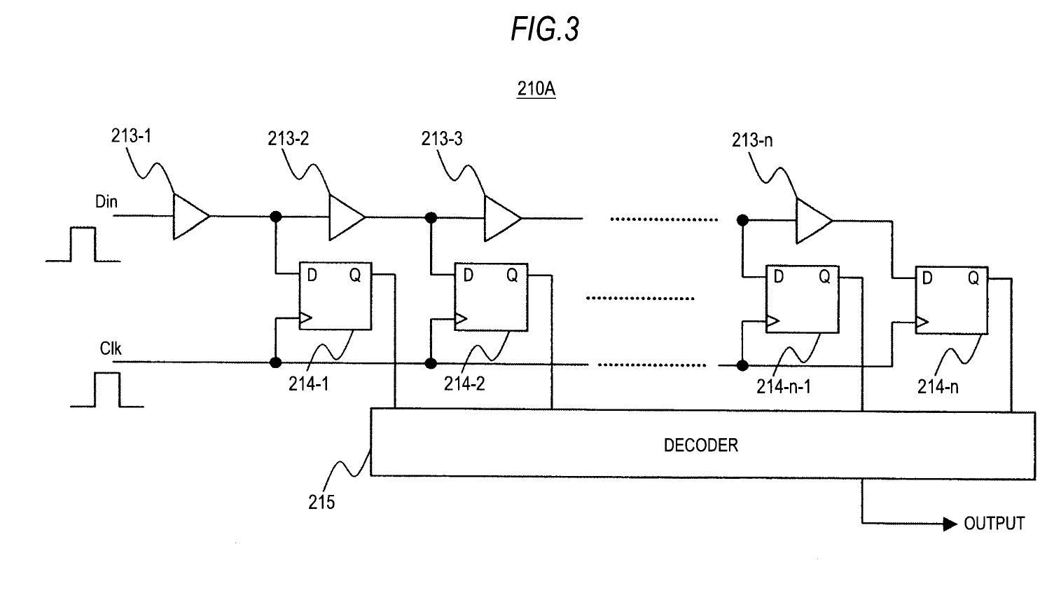

FIG. 3 is a diagram showing a second configuration example of the delay information monitor according to the embodiment.

A delay information monitor 210A of FIG. 3 includes a so-called pulse delay measurement circuit.

The delay information monitor 210A of FIG. 3 includes buffers 213-1, 213-2, . . . , 213-n which are cascade-connected, latches 214-1, 214-2, . . . , 214-n using D flip-flops and a decoder 215.

Respective outputs of the buffers 213-1, 213-2, . . . , 213-n are connected to corresponding D-inputs of the latches 214-1, 214-2, . . . , 214-n.

Clock terminals of respective latches 214-1, 214-2, . . . , 214-n are connected to a supply line of a clock pulse Clk of supply, and Q-outputs of respective latches 214-1, 214-2, . . . , 214-n are inputted to the decoder 215.

In the above configuration, when a pulse Din is inputted to the buffers 213-1, 213-2, 213-n which are cascaded-connected, the pulse is sequentially propagated.

Subsequently, when the clock pulse Clk for measurement is inputted after a given period of time has been passed from the input of the pulse Din, the latches 214-1, 214-2, . . . , 214-n connected in parallel to respective buffers in a buffer line latch output signals from respective buffers all at once.

When the signal is propagated to the m-th stage when the output signals are latched, outputs from the latches will be m-pieces of “1” and (n-m) pieces of “0”. These outputs are decoded in the decoder 215 to thereby generate an output signal.

The delay information monitor 121 is not limited to the configurations of FIG. 2 and FIG. 3, and various configurations such as the configurations disclosed in Patent Documents 1, 2 can be applied.

The delay information manager 122 manages output values from the delay information monitors 121-1 to 121-n and outputs the selected value or the values in the form as they are to the power supply 1013.

The power supply IC 13 includes a power supply terminal T131, a ground terminal T132 and a voltage output terminal T133.

To the power supply terminal T131, a voltage V1 is supplied from an external power supply, for example, a battery.

The ground T132 is connected to the ground GND of the package substrate 11.

A delay information register 131, a lookup table (LUT) 132, a voltage control circuit 133 and an output buffer 134 are mounted on the power supply IC 13.

The delay information register 131 takes and holds delay information values outputted from the delay information manager 122 of the LSI 112.

The retention information of the delay information register 131 is referred to at the LUT 132.

Here, the bit number of the delay information register 131 is not limited. In FIG. 1, control and function pins in the LSI 12 and the like are omitted, however, control is performed by an external control device represented by an LSI tester and so on.

The output values of the delay information monitors 121 in the LSI 12 are taken to the delay information register 131 in the power supply IC 13 directly or through the delay information manager 122, and directness or indirectness is not limited.

The LUT 132 refers to a delay information value of the delay information register 131 and indicates a voltage value VI corresponding to the reference value to the voltage control circuit 133.

As described above, when delay information is measured at a fixed reference voltage, the LSI having slow operation speed of the transistor in manufacturing variation of LSIs has a large delay value, and the LSI having high operation speed has a small delay value.

Therefore, it is necessary to increase the power supply voltage to satisfy time constraint in operation of the LSI when the delay value is large.

The LSI with the small delay value can operated at lower voltage.

Data of relation between delay information and the minimum operation power supply voltage as described above is measured at an evaluation stage of the LSI, and the data is stored in the LUT 32 in advance.

The LUT 132 includes an LUT for delay values 1321 and an LUT for voltage values 1322.

The LUT 132 determines the voltage value VI corresponding to relation between delay information and the minimum operation power supply voltage by referring to the value of the delay information register 131 using the LUT for delay values 1321 and by referring to the delay value corresponding to the reference value using the LUT for voltage values 1322.

As shown in FIG. 1, the LUT 132 can be used for general purpose with respect to not only a peculiar LSI but also many LSIs by allowing the LUT 132 to be rewritable through a LUT interface 135.

The LUT 132 may be formed in a pair or plural pairs in the number of arrangement.

When the non-volatile memory is used for the delay information register 131 and the LUT 132, a sequential sequence of delay measurement and the voltage indication from the LSI is not necessary when the value is written before shipping the product.

The voltage control circuit 133 controls the output buffer 134 so as to output the voltage value indicated by the LUT 132.

The output buffer 134 includes a p-channel MOS (PMOS) transistor PT11 and an n-channel MOS (NMOS) transistor NT11.

A source of the PMOS transistor PT11 is connected to the power supply terminal T131 and a drain is connected to the voltage output terminal T133.

A source of the NMOS transistor NT11 is connected to the ground terminal T132 and a drain is connected to the voltage output terminal T133.

Then, gate voltages of the PMOS transistor PT11 and the NMOS transistor NT11 are controlled at the voltage control circuit 133 to control the output voltage value.

An output voltage value VO is controlled in a range, for example, GND<VO≦VI.

The smoothing circuit 14 includes an inductor L14 and a capacitor C14.

The smoothing circuit 14 smoothes the voltage V0 outputted from the power supply IC 13 and supplies the voltage to the power supply terminal T121 of the LSI 12 as the voltage Vstd.

Here, an example of a power supply voltage control process by delay information according to the first embodiment will be explained.

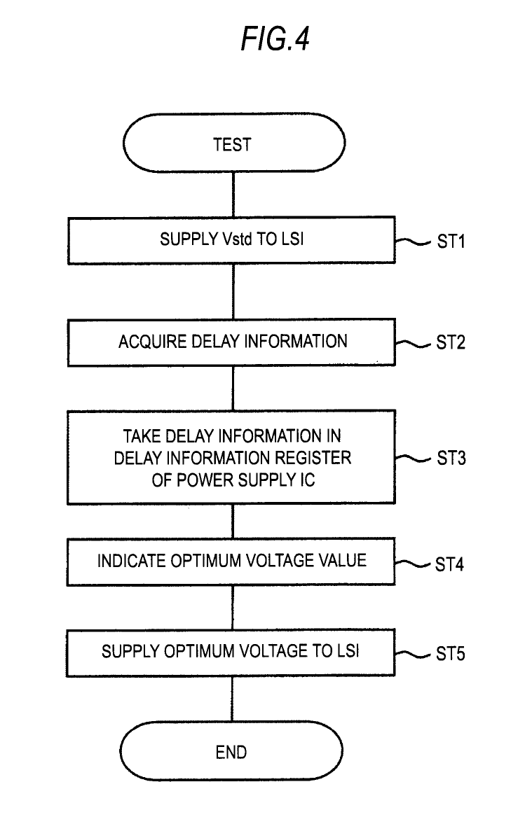

FIG. 4 is a flowchart for explaining the example of the power supply voltage control process by delay information according to the first embodiment.

In the present embodiment, the voltage Vstd to be the reference is supplied from the power supply IC 13 to the LSI 12, for example, at the time of performing a quality test of products mounted on the same package substrate 11 (ST1).

Then, delay information of the LSI 12 is acquired by the delay information monitors 121 in the LSI 12 under the state in which power supply voltage is Vstd (ST2), and the output value is taken in the delay information register 131 in the power supply IC 13 through the delay information manager 122 (ST3).

The LUT 132 indicates the voltage value VI to the voltage control circuit 133 by referring to the value of the delay information register 131 (ST4).

The voltage control circuit 133 controls the output buffer 134 to output the voltage value indicated by the LUT 132 (ST5).

In the manner as described above, the power voltage which has been individually optimized can be supplied to the LSI.

According to the first embodiment, delay information of the LSI to be paired with the power supply IC 13 in the package or on the actual device substrate is stored in the delay information register 131 in the power supply IC 13.

At the time of a shipping test of the LSI 12 or at the time of an operation test of the set, a given voltage is generated from the power supply IC 13 and delay information of the delay information monitor 121 in the LSI 12 is read in that state, then, the delay information is stored in the delay information register 131 in the power supply IC.

The reading of delay information is performed only at the time of the shipping test of the LSI 12 or at the time of the operation test of the set, therefore, it is not necessary to secure a dedicated pin in the LSI 12 when used in the actual device.

As the power supply IC 13 directly has information of the LSI to be paired with the IC, the power supply IC 13 can supply the optimum voltage to the LSI 12 to be paired immediately.

According to this, it is possible to reduce man-hour of system development because firmware intervention is not necessary at the time of normal operation.

### 2. Second Embodiment

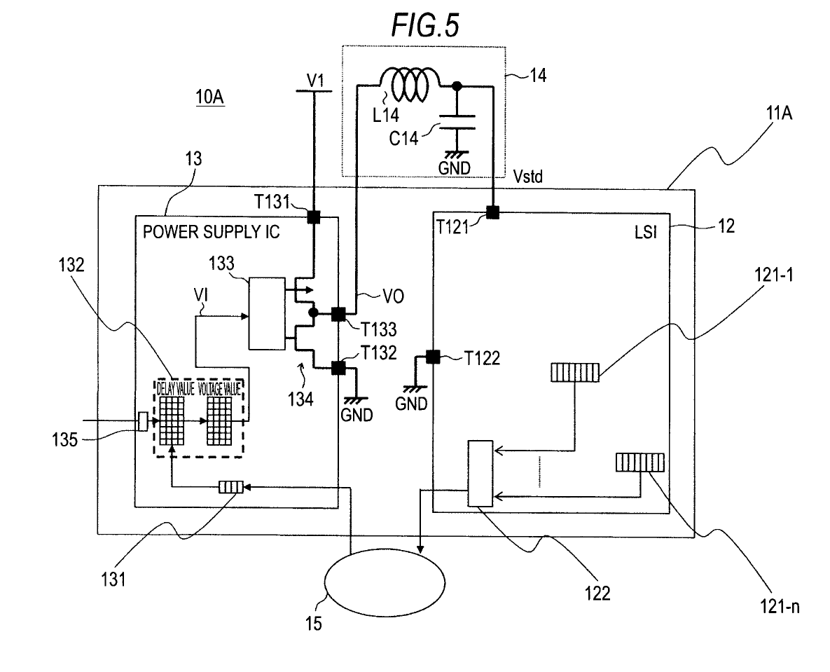

FIG. 5 is a diagram showing a configuration example of a semiconductor device according to a second embodiment of the invention.

A semiconductor device 10A according to the second embodiment differs from the semiconductor device 10 according to the first embodiment in a point described below.

In the first embodiment, the LSI 12 and the power supply IC 13 are directly connected in the package substrate 11.

On the other hand, in the second embodiment, delay information from the LSI 12 is read by an external control device 15 represented by an LSI tester and so on and the value thereof is written in the delay information register 131 of the power supply IC 13.

According to the second embodiment, the same advantages as the advantages of the above first embodiment can be obtained.

### 3. Third Embodiment

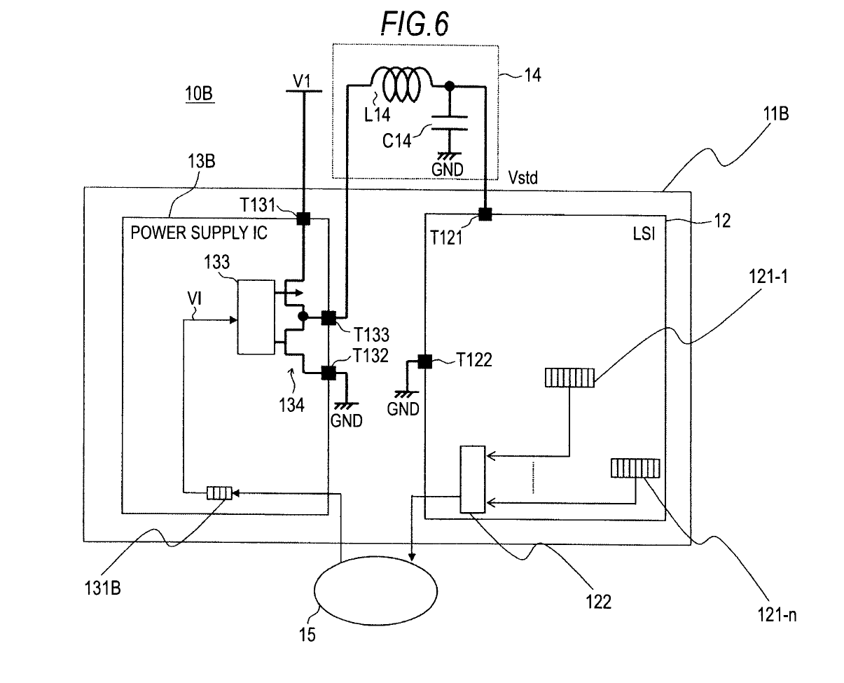

FIG. 6 is a diagram showing a configuration example of a semiconductor device according to a third embodiment of the invention.

A semiconductor device 10B according to the third embodiment differs from the semiconductor device 10A according to the second embodiment in a point described below.

In the third embodiment, delay information from the LSI 12 is read by the external control device 15, database of delay information/minimum operation power supply voltage included on the external control device 15 is referred and a corresponding voltage value is written in a delay information register 131B of a power supply IC 13B.

The voltage control circuit 133 refers to the voltage value of the delay information register 131B and supplies individually-optimized power supply voltage to the LIS 12.

The database of delay information/minimum operation power supply voltage corresponds to, for example, the contents of the LUT (lookup table in the first embodiment).

Therefore, in the third embodiment, the LUT is cut from the power supply IC 13B, and the voltage value stored in the delay information register 131B is directly referred by the voltage control circuit 133.

### 4. Fourth Embodiment

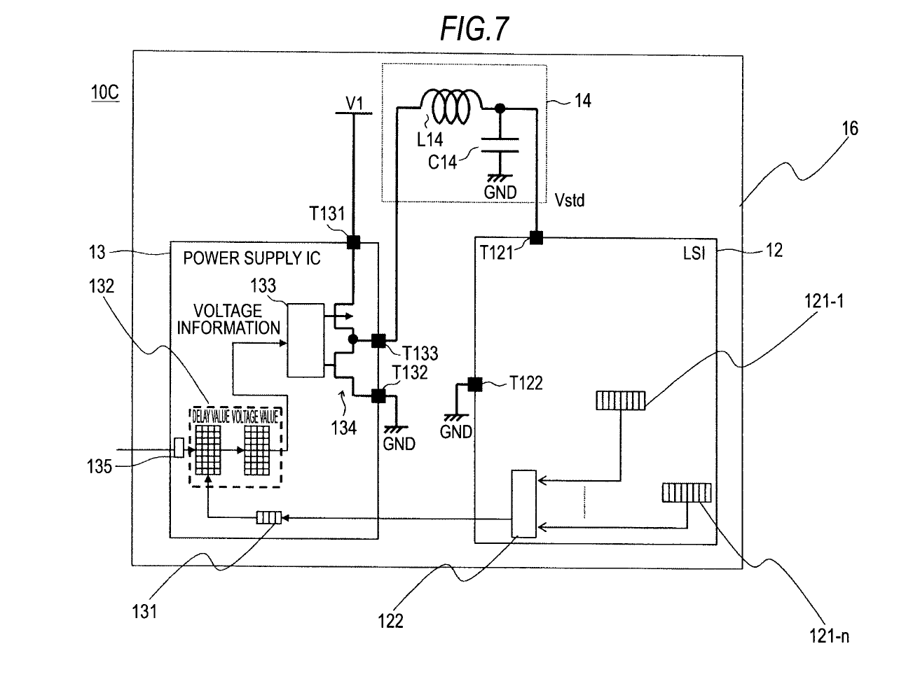

FIG. 7 is a diagram showing a configuration example of a semiconductor device according to a fourth embodiment of the invention.

A semiconductor device 10C according to the fourth embodiment differs from the semiconductor device 10 according to the first embodiment in a point described below.

In the fourth embodiment, the whole semiconductor device 100 is arranged on an actual device substrate 16, not on the package substrate of the first embodiment.

According to the fourth embodiment, the same advantages as advantages of the above first embodiment can be obtained.

In respective embodiments, a switching power supply is shown for convenient, however, the type of the power supply and the type of the smoothing are not limited.

As described above, according to the embodiments, the optimum power supply voltage can be supplied to each LSI, therefore, waste power consumption can be suppressed.

As communication between the power supply IC 13 and the LSI 12 is not necessary at the time of operating the actual device, the number of pins on the side of the LSI 12 can be reduced.

As firmware for controlling the power supply IC 13 is not necessary at the time of operating the actual device, costs for development and verification of firmware can be suppressed.

As it is not necessary to provide nonvolatile storage elements on the side of the LSI 12 costs of which are high, increase of manufacturing costs of the LSI can be suppressed. In general, the power supply IC is manufactured in processes of old technologies in view of withstand voltage and costs in many cases.

The measurement of delay/voltage and determination of the operation voltage are performed on the actual device in the combination of the power supply IC 13 and the LSI 12 which are paired with each other, therefore, variations in respective characteristics can be compensated.

The present application contains subject matter related to that disclosed in Japanese Priority Patent Application JP 2009-217472 filed in the Japan Patent Office on Sep. 18, 2009, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A semiconductor device comprising:
a power supply voltage generating circuit generating a power supply voltage corresponding to delay information; and
an integrated circuit to which the power supply voltage is supplied from the power supply voltage generating circuit,
wherein the integrated circuit includes at least one delay information monitor monitoring delay information at the time of operation when the power supply voltage is supplied from the power supply voltage generating circuit and a delay information manager managing delay information acquired by the delay information monitor,
the power supply voltage generating circuit includes a delay information register which can hold delay information relating to delay information by the delay information monitor and a voltage control circuit generating the power supply voltage corresponding to delay information stored in the delay information register and supplies the voltage to the integrated circuit.

2. The semiconductor device according to claim 1,
wherein the delay information register directly stores delay information of the integrated circuit to be paired.

3. The semiconductor device according to claim 1,
wherein the delay information register stores delay information of the integrated circuit to be paired through an external control device.

4. The semiconductor device according to any one of claims 1 to 3,
wherein the power supply voltage generating circuit includes a lookup table converting delay information stored in the delay information register into a corresponding voltage value and indicating the voltage value to the voltage control circuit, and
the voltage control circuit generates a power supply voltage corresponding to the indicated voltage value and supplies the voltage to the integrated circuit.

5. The semiconductor device according to claim 4,
wherein the lookup table is formed in a pair or plural pairs in the number of arrangement.

6. The semiconductor device according to claim 4 or 5,
wherein the contents of the lookup table which converts delay information into the voltage value can be rewritten from the outside.

7. The semiconductor device according to any one of claims 4 to 6,
wherein the lookup table which converts delay information into the voltage value is formed by a nonvolatile storage element.

8. The semiconductor device according to claim 1,
wherein the delay information register stores voltage values corresponding to delay information of the integrated circuit to be paired.

9. The semiconductor device according to claim 8,
wherein the delay information register stores voltage values obtained by converting delay information of the integrated circuit to be paired into corresponding voltage values in the external control circuit.

10. The semiconductor device according to claim 8 or 9,
wherein the voltage control circuit generates a power supply voltage corresponding to the voltage value stored in the delay information register and supplies the voltage to the integrated circuit.

11. The semiconductor device according to any one of claims 1 to 10,
wherein the delay information register storing the delay information is formed by a nonvolatile storage element.
